(19) United States
(12) Patent Application Publication
(10) Pub. No.: US 2026/0281408 A1
(43) Pub. Date: Sep. 17, 2026

(54) VIDEO ENCODING/DECODING METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Xiaozhong XU, Shenzhen (CN)

(73) Assignee: TENCENT TECHNOLOGY (SHENZHEN) COMPANY LIMITED, Shenzhen (CN)

(21) Appl. No.: 19/674,256

(22) Filed: May 12, 2026

Related U.S. Application Data
(63) Continuation of application No. PCT/CN2025/111658, filed on Jul. 31, 2025.

(30) Foreign Application Priority Data
Aug. 9, 2024 (CN) 202411096730.6

(51) Int. Cl. H04N 19/44; H04N 19/105; H04N 19/137; H04N 19/167; H04N 19/176; H04N 19/51

(52) U.S. Cl. CPC H04N 19/44; H04N 19/105; H04N 19/137; H04N 19/167; H04N 19/176; H04N 19/51

(57) ABSTRACT

A video decoding method, apparatus, and computer-readable storage medium for enhanced motion compensation through motion vector refinement. The method decodes a video bitstream to obtain a first motion vector for a current block, then identifies candidate positions in a reference frame associated with this vector. A target position is selected from candidates based on two criteria: the encoding cost of the second motion vector indicated by the target position must exceed the first motion vector's encoding cost, and pixel distortion between the current block and reference block at the target position must remain below a threshold. A second motion vector is determined from this target position and used for motion compensation, enabling improved video quality through controlled motion vector refinement.

### CROSS-REFERENCE TO RELATED APPLICATIONS

This application is a continuation application of International Application No. PCT/CN2025/111658 filed on Jul. 31, 2025 which claims priority to Chinese Patent Application No. 202411096730.6, filed with the China National Intellectual Property Administration on Aug. 9, 2024, the disclosures of each being incorporated by reference herein in their entireties.

### FIELD

The disclosure relates to the field of computers, a video encoding/decoding method and apparatus, a device, a storage medium, and a program product.

### BACKGROUND

In the related art, in the inter prediction mode, a pixel of a current image is predicted based on the temporal correlation in a video and a pixel of an adjacent encoded image (namely, a reference image), to achieve the objective of effectively removing temporal redundancy in the video. A process of searching for an optimal reference block in the reference image is referred to as motion estimation.

During motion estimation, one position with “optimal” encoding efficiency needs to be selected from a plurality of possible candidate positions by using a cost function. However, a prediction block position selected when the cost function is minimized may not be optimal in terms of block compensation (prediction) effect. Consequently, a determined motion vector (MV) may be inaccurate, which in turn affects video encoding/decoding efficiency.

### SUMMARY

Provided are a video decoding method and apparatus, a device, a storage medium, and a program product, which can implement enhanced motion compensation through selective motion vector refinement based on encoding cost and pixel distortion criteria.

According to some embodiments, a video decoding method, performed by an electronic device, includes: decoding a video bitstream to obtain a first motion vector of a current block; identifying, in a reference frame, a plurality of candidate positions associated with the first motion vector; selecting a target position from the plurality of candidate positions; determining a second motion vector of the current block based on the target position, wherein the target position satisfies: a first condition that a second encoding cost of the second motion vector indicated by the target position exceeds a first encoding cost of the first motion vector, and a second condition that a pixel distortion between the current block and a reference block containing the target position is below a threshold; and performing motion compensation on the current block based on the second motion vector.

According to some embodiments, a video decoding apparatus, includes: at least one memory configured to store program code; and at least one processor configured to read the program code and operate as instructed by the program code, the program code including: decoding code configured to cause at least one of the at least one processor to decode a video bitstream to obtain a first motion vector of a current block; identification code configured to cause at least one of the at least one processor to identify, in a reference frame, a plurality of candidate positions associated with the first motion vector; selection code configured to cause at least one of the at least one processor to select a target position from the plurality of candidate positions; determination code configured to cause at least one of the at least one processor to determine a second motion vector of the current block based on the target position, wherein the target position satisfies: a first condition that a second encoding cost of the second motion vector indicated by the target position exceeds a first encoding cost of the first motion vector, and a second condition that a pixel distortion between the current block and a reference block containing the target position is below a threshold; and compensation code configured to cause at least one of the at least one processor to perform motion compensation on the current block based on the second motion vector.

According to some embodiments, a non-transitory computer-readable storage medium, storing computer code which, when executed by at least one processor, causes the at least one processor to at least: decode a video bitstream to obtain a first motion vector of a current block; identify, in a reference frame, a plurality of candidate positions associated with the first motion vector; select a target position from the plurality of candidate positions; determine a second motion vector of the current block based on the target position, wherein the target position satisfies: a first condition that a second encoding cost of the second motion vector indicated by the target position exceeds a first encoding cost of the first motion vector, and a second condition that a pixel distortion between the current block and a reference block containing the target position is below a threshold; and perform motion compensation on the current block based on the second motion vector.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an exemplary system architecture to some embodiments.

FIG. 2 is a schematic diagram of a placement manner of a video encoding apparatus and a video decoding apparatus in a streaming transmission system.

FIG. 3 is a flowchart of a video encoder.

FIG. 4 is a schematic diagram of an inter prediction process.

FIG. 5 is a schematic diagram of an inter prediction process.

FIG. 6 is a flowchart of a video decoding method according to some embodiments.

FIG. 7 is a flowchart of a video encoding method according to some embodiments.

FIG. 8 is a schematic diagram of a search region according to some embodiments.

FIG. 9 is a block diagram of a video decoding apparatus according to some embodiments.

FIG. 10 is a block diagram of a video encoding apparatus according to some embodiments.

FIG. 11 is a schematic structural diagram of an electronic device suitable for implementing embodiments of this application.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Exemplary implementations are described more comprehensively with reference to the drawings. However, the exemplary implementations can be implemented in various forms and are not to be construed as being limited to the examples set forth herein. Rather, these implementations are provided to make this application more thorough and complete, and to fully convey the concept of the exemplary embodiments to a person skilled in the art.

In addition, the features, structures, or characteristics described in this application may be combined in one or more embodiments in any proper manner. In the following description, numerous details are set forth to provide a thorough understanding of the embodiments of this application. However, a person skilled in the art will appreciate that it is possible to implement the technical solutions of this application without employing all the detailed features in the embodiments. One or more details may be omitted, or another method, element, apparatus, step, or the like may be adopted instead.

In the embodiments of this application, the term “module” or “unit” refers to a computer program with a preset function or a part of the computer program and operates, together with other related parts, to achieve a predetermined goal, and may be completely or partially implemented by using software, hardware (such as a processing circuit or a memory), or a combination thereof. Similarly, one processor (or a plurality of processor or a memory) may be configured to implement one or more modules or units. In addition, each module or unit may be a part of an overall module or unit including the functionality of the module or unit.

The block diagrams shown in the drawings are merely functional entities, and do not necessarily correspond to physically independent entities. To be specific, the functional entities may be implemented in the form of software, or in one or more hardware modules or integrated circuits, or in different networks and/or processor apparatuses and/or microcontroller apparatuses.

The flowcharts shown in the drawings are merely exemplary descriptions, and do not necessarily include all content and operations/steps, nor are they necessarily performed in the order described. For example, some operations/steps may further be broken down, and some operations/steps may be combined or partially combined. Therefore, the actual execution order may vary depending on the circumstances.

“A plurality of” mentioned herein means two or more. “And/or” describes an association relationship between associated objects and represents that three relationships may exist. For example, A and/or B may represent the following three cases: Only A exists, both A and B exist, and only B exists. The character “/” generally denotes an “or” relationship between the associated objects.

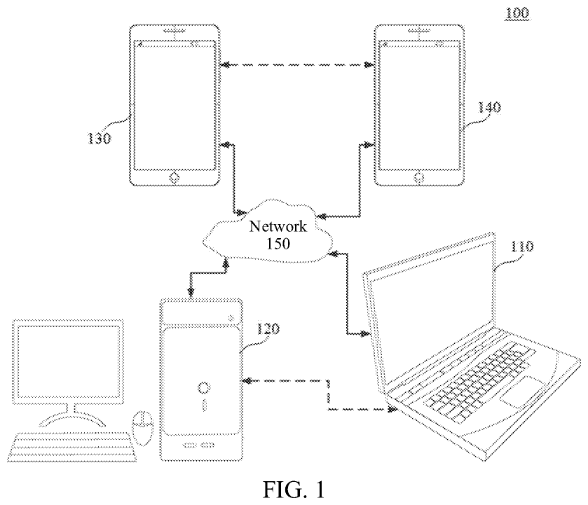

FIG. 1 is a schematic diagram of an exemplary system architecture to which a technical solution of embodiments of this application is applicable.

As shown in FIG. 1, a system architecture 100 includes a plurality of terminal apparatuses. The terminal apparatuses may communicate with each other over, for example, a network 150. For example, the system architecture 100 may include a first terminal apparatus 110 and a second terminal apparatus 120 that are interconnected via the network 150. In the embodiment of FIG. 1, the first terminal apparatus 110 and the second terminal apparatus 120 perform unidirectional data transmission.

For example, the first terminal apparatus 110 may encode video data (such as a video picture stream captured by the terminal apparatus 110) for transmission to the second terminal apparatus 120 over the network 150. The encoded video data is transmitted in the form of at least one encoded video bitstream. The second terminal apparatus 120 may receive the encoded video data over the network 150, decode the encoded video data to recover the video data, and display a video picture based on the recovered video data.

In some embodiments, the system architecture 100 may include a third terminal apparatus 130 and a fourth terminal apparatus 140 that perform bidirectional transmission of encoded video data. The bidirectional transmission may occur, for example, during a video meeting. For bidirectional transmission of data, one terminal apparatus of the third terminal apparatus 130 and the fourth terminal apparatus 140 may encode video data (such as a video picture stream captured by the terminal apparatus) for transmission to the other terminal apparatus of the third terminal apparatus 130 and the fourth terminal apparatus 140 over the network 150. One terminal apparatus of the third terminal apparatus 130 and the fourth terminal apparatus 140 may further receive encoded video data transmitted by the other terminal apparatus of the third terminal apparatus 130 and the fourth terminal apparatus 140, decode the encoded video data to recover video data, and display a video picture on an accessible display apparatus based on the recovered video data.

In the embodiment shown in FIG. 1, the first terminal apparatus 110, the second terminal apparatus 120, the third terminal apparatus 130, and the fourth terminal apparatus 140 may be servers or terminals, but the principle disclosed in this application may not be limited thereto.

The server may be an independent physical server, or a server cluster or distributed system including a plurality of physical servers, or a cloud server that provides cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal may be, but is not limited to, a smartphone, a tablet computer, a notebook computer, a desktop computer, a smart speaker, a smart voice interaction device, a smart watch, a smart household appliance, an in-vehicle terminal, an aircraft, or the like.

The network 150 shown in FIG. 1 represents any quantity of networks for transmitting encoded video data between the first terminal apparatus 110, the second terminal apparatus 120, the third terminal apparatus 130, and the fourth terminal apparatus 140, and includes, for example, a wired and/or wireless communication network. The communications network 150 may exchange data in a circuit-switched and/or packet-switched channel. The network may include a telecommunication network, a local area network (LAN), a wide area network, and/or the Internet. For the purpose of this application, unless otherwise explained below, an architecture and a topology of the network 150 may be inconsequential to operations disclosed in this application.

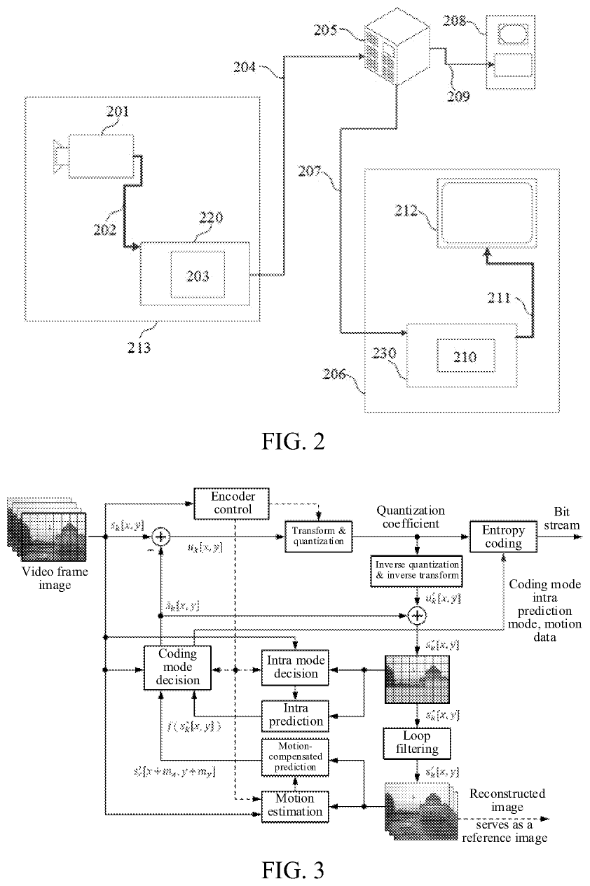

In some embodiments, FIG. 2 is a diagram of a placement manner of a video encoding apparatus and a video decoding apparatus in a streaming transmission environment. The subject matter disclosed in this application may be equally applicable to other applications supporting a video, including, for example, video conferencing, a digital television (TV), and storing a compressed video on a digital medium including a compact disc (CD), a digital versatile disc (DVD), a memory stick, and the like.

The streaming transmission system may include a capture subsystem 213. The capture subsystem 213 may include a video source 201 such as a digital camera. The video source creates an uncompressed video picture stream 202. In some embodiments, the video picture stream 202 includes a sample shot by the digital camera. Compared with encoded video data 204 (or an encoded video bitstream 204), the video picture stream 202 is drawn as a thick line to emphasize a video picture stream with a high data volume. The video picture stream 202 may be processed by an electronic apparatus 220. The electronic apparatus 220 includes a video encoding apparatus 203 coupled to the video source 201. The video encoding apparatus 203 may include hardware, software, or a combination of software and hardware to implement or practice aspects of the disclosed subject matter described in more detail below. Compared with the video picture stream 202, the encoded video data 204 (or the encoded video bitstream 204) is drawn as a thin line to emphasize the encoded video data 204 (or the encoded video bitstream 204) with a low data volume, and the encoded video data may be stored on a streaming transmission server 205 for future use. At least one streaming transmission client subsystem, such as a client subsystem 206 and a client subsystem 208 in FIG. 2, may access the streaming transmission server 205 to retrieve a copy 207 and a copy 209 of the encoded video data 204. The client subsystem 206 may include, for example, a video decoding apparatus 210 in an electronic apparatus 230. The video decoding apparatus 210 decodes the incoming copy 207 of the encoded video data, and generates an output video picture stream 211 that may be presented on a display 212 (such as a display screen) or another presentation apparatus. In some streaming transmission systems, the encoded video data 204, video data 207, and video data 209 (such as video bitstreams) may be encoded according to some video coding/compression standards.

The electronic apparatus 220 and the electronic apparatus 230 may include another component not shown in the figure. For example, the electronic apparatus 220 may include a video decoding apparatus, and the electronic apparatus 230 may further include a video encoding apparatus.

In some embodiments, the national video coding standards, namely, High Efficiency Video Coding (HEVC) and Versatile Video Coding (VVC), and the China national video coding standard, namely, Audio Video Coding Standard (AVS) are used as an example. After being inputted, one video frame is partitioned into several non-overlapping processing units according to a block size, and a similar compression operation is performed on each processing unit. The processing unit is referred to as a coding tree unit (CTU) or a largest coding unit (LCU). The CTU may further be partitioned more finely downward, to obtain at least one coding unit (CU). The CU is a most element in an encoding process.

In another embodiment, this processing unit may alternatively be referred to as a tile, which is a rectangular region of a multimedia data frame that can be independently decoded and encoded. In the Alliance for Open Media Video 1 (AV1) standard, the tile may further be partitioned more finely downward, to obtain at least one superblock (SB). The SB is a starting point of block partitioning, may further be partitioned into a plurality of sub-blocks, and the sub-block is further partitioned downward, to obtain at least one block. Each block is a most element in an encoding process. In some embodiments, one SB may include several blocks.

The foregoing partitioning method for the video frame image may be referred to as a block partition structure. Some concepts involved in an encoding process are described below.

Predictive coding: predictive coding includes modes such as intra prediction and inter prediction. A residual video signal is obtained after an original video signal is predicted based on a selected reconstructed video signal. An encoding side needs to select a predictive coding mode for a current CU (or coding block), and inform a decoding side of the predictive coding mode. Intra prediction means that a predicted signal is from an encoded and reconstructed region of a same image. Inter prediction means that a predicted signal is from another encoded image (referred to as a reference image) different from a current image.

Transform and quantization: after undergoing a transform operation such as Discrete Fourier Transform (DFT) or Discrete Cosine Transform (DCT), a residual signal is converted into transform domain, and a result is referred to as a transform coefficient. A lossy quantization operation is further performed on the transform coefficient, to lose an amount of information. In this way, a quantized signal facilitates compressed expression. In some video coding standards, more than one transform mode may be provided for selection. Therefore, the encoding side also needs to select one transform mode for the current CU (or coding block), and inform the decoding side of the transform mode. Quantization fineness is usually determined based on a quantization parameter (QP). A larger QP value indicates that coefficients within a larger value range are quantized to a same output, which usually in turn leads to greater distortion and a lower bit rate. On the contrary, a smaller QP value indicates that coefficients within a smaller value range are quantized to a same output, which usually in turn leads to smaller distortion and a higher bit rate.

Entropy coding or statistical coding: statistical compression coding is performed on a quantized transform domain signal according to occurrence frequencies of values, and finally a binarized (0 or 1) compressed bitstream is outputted. Meanwhile, other information generated through encoding, such as a selected coding mode and motion vector (MV) data, also needs to undergo entropy coding to reduce a bit rate. Statistical coding is a lossless coding mode, and can effectively reduce a bit rate for expressing a same signal. A common statistical coding mode includes Variable Length Coding (VLC) or Content Adaptive Binary Arithmetic Coding (CABAC).

A process of CABAC mainly includes three operations: binarization, context modeling, and binary arithmetic coding. After an inputted syntax element is binarized, binary data may be encoded in a coding mode and a bypass coding mode. In the bypass coding mode, a probability model does not need to be assigned to each binary bit, and an inputted binary bit bin value is directly encoded by using a simple bypass encoder, to accelerate entire encoding and decoding. Generally, different syntax elements are not completely independent of each other, and a same syntax element also has a degree of memory. Therefore, according to the conditional entropy theory, conditional coding is performed based on another encoded syntax element, and the encoding performance can be further improved compared with independent coding or memoryless coding. Encoded symbol information used as a condition is referred to as a context. In the coding mode, binary bits of a syntax element sequentially enter a context modeler. An encoder assigns an appropriate probability model to each inputted binary bit based on a value of a previously encoded syntax element or binary bit. This process is referred to as context modeling. A context model corresponding to the syntax element may be positioned according to a context index increment (ctxIdxInc) and a context index start (ctxIdxStart). After the bin value and the assigned probability model are both inputted to a binary arithmetic encoder for encoding, the context model needs to be updated based on the bin value. This is referred to as an adaptation process during encoding.

Loop filtering: a reconstructed image is obtained by performing operations of inverse quantization, inverse transform, and prediction compensation on a transformed and quantized signal. Compared with an original image, due to the effect of quantization, the reconstructed image has partial information different from the original image, that is, the reconstructed image may produce distortion. Therefore, a filtering operation may be performed on the reconstructed image by using a filter such as deblocking filter (DB), a sample adaptive offset (SAO), or an adaptive loop filter (ALF), to effectively reduce a degree of distortion produced by quantization. Because these filtered reconstructed images are used as a reference for subsequent image encoding to predict a future image signal, the foregoing filtering operation is also referred to as loop filtering, namely, a filtering operation within an encoding loop.

In some embodiments, FIG. 3 is a flowchart of a video encoder. In this process, a description is made by using intra prediction as an example. A difference operation is performed on an original image signal and a predicted image signal, to obtain a residual signal. The residual signal is converted and quantized to obtain a quantization coefficient. Entropy coding is performed on the quantization coefficient to obtain an encoded bit stream. Meanwhile, inverse quantization and inverse transform are performed on the quantization coefficient to obtain a reconstructed residual signal. The predicted image signal and the reconstructed residual signal are superimposed to generate an image signal. The image signal is inputted to an intra mode decision module and an intra prediction module for intra prediction. Meanwhile, a reconstructed image signal is outputted through loop filtering. The reconstructed image signal may be used as a reference image of a next frame for motion estimation and motion-compensated prediction. Then, a predicted image signal of the next frame is obtained based on a motion-compensated prediction result and an intra prediction result, and the foregoing process is repeated until encoding is completed.

Based on the foregoing encoding process, after obtaining a compressed bitstream (namely, a bit stream), a decoding side performs entropy decoding on each CU (or coding block), to obtain various mode information and quantization coefficients. Then, inverse quantization and inverse transform are performed on the quantization coefficient, to obtain a residual signal. Meanwhile, according to known coding mode information, a predicted signal corresponding to the CU (or the coding block) may be obtained. Then, a reconstructed signal may be obtained by superimposing the residual signal and the predicted signal, and an operation, such as loop filtering, is performed on the reconstructed signal to generate a final output signal.

In the field of encoding technologies, during inter prediction, a pixel of a current image is predicted based on the temporal correlation in a video and a pixel of an adjacent encoded image, to achieve the objective of effectively removing temporal redundancy in the video, whereby bits for encoding residual data can be effectively saved.

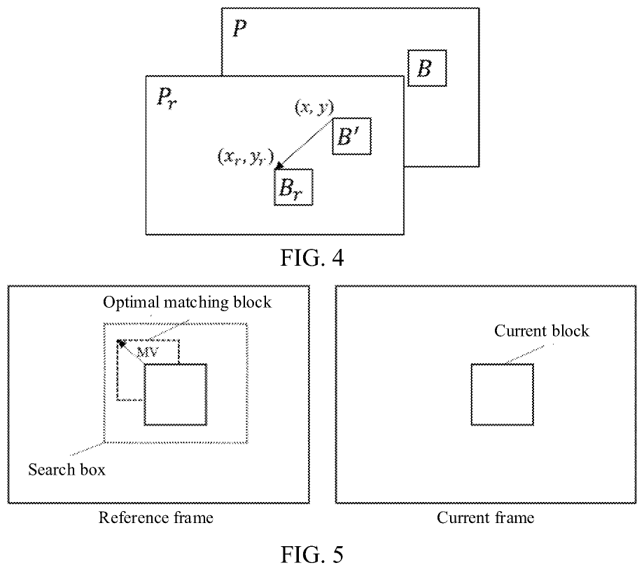

As shown in FIG. 4, P represents a current frame, Pr represents a reference frame (or a reference image), B represents a current coding block, and Br represents a reference block of B. Coordinates of B′ in the reference frame are the same as coordinate positions of B in the current frame. Coordinates of Br are (xr, yr), coordinates of B′ are (x, y), and a displacement between the current coding block and the reference block of the current coding block is referred to as an MV, where MV=(xr-x, yr-y). In other words, inter prediction refers to a process of searching an adjacent encoded image (that is, a reference frame) based on a to-be-encoded current block in a current frame, to obtain a reference block, with the objective of removing temporal redundancy in a video signal.

As shown in FIG. 5, for a to-be-encoded current block in a current frame, a search is performed within a range (that is, in a search region formed by a search box) in a reference frame according to a block matching criterion, to obtain an optimal matching reference block, which is briefly referred to as an optimal matching block. In some embodiments, common block matching criteria in video coding include matching criteria such as Mean Square Error (MSE) and Sum of Absolute Difference (SAD).

Considering that adjacent blocks in time domain or space domain have strong correlation, an MV prediction technology may be employed to further reduce bits for encoding an MV. In some audio/video standards, such as H.265/HEVC, inter prediction includes two MV prediction technologies: Merge and Advanced Motion Vector Prediction (AMVP).

In the Merge mode, an MV candidate list is established for the current block. For example, the MV candidate list includes five candidate MVs (and reference images corresponding to the five candidate MVs). The five candidate MVs are traversed, and a candidate MV with minimum rate-distortion cost is selected as an optimal MV. If an encoder and a decoder establish the MV candidate list in the same manner, the encoder only needs to transmit an index of the optimal MV in the MV candidate list.

In HEVC, the MV prediction technology further has a skip mode, which is a example of the Merge mode. After the optimal MV is found by using the Merge mode, if the current block and the reference block are basically the same, residual data does not need to be transmitted, and only the index of the MV and one skip flag need to be transmitted.

Similarly, in the AMVP mode, a candidate motion vector predictor (MVP) list is established for the current block based on the MV correlation between adjacent blocks in space domain and time domain. Different from the Merge mode, the candidate MVP list of the AMVP mode includes a plurality of MVPs, that is, predictors of MVs, which are briefly referred to as MVPs. An optimal MVP is selected from the candidate MVP list, and differential coding is performed on the optimal MVP and the optimal MV obtained through motion search for the current block, that is, encodes a motion vector difference (MVD), where MVD=MV-MVP. After establishing the same list, the decoding side can calculate the MV of the current block based on only the sequence number of the MVP in the list and the MVD. In AMVP, the candidate MV list also includes two cases: space domain and time domain.

In a motion estimation process of the inter prediction technology, an “optimal” position block needs to be selected from a plurality of possible candidate positions by using a cost function as a reference block of a current block, and is employed for inter prediction. In an example, the cost function includes pixel distortion (D) of block matching and an encoding efficiency bit rate (R) of an MV. For example, the cost function may be expressed as J=D+λ×R, where J represents the cost function, and A represents a parameter configured for balancing the pixel distortion D and the encoding efficiency R at different bit rates.

Generally, when a reference block for motion compensation is finally selected, the selection is not based on minimum D or R cost individually, but rather on a block position that minimizes the foregoing cost function J, namely, a block position with a minimum weighted combination of D and R. However, a position block or a reference block selected when the cost function is minimized may not be optimal in terms of block compensation (prediction) effect. Consequently, a determined MV is inaccurate, which in turn affects video encoding/decoding efficiency.

Based on this, in the technical solution of the embodiments of this application, the original MV of the current block may be optimized to reduce pixel distortion and improve accuracy of the optimized MV. This facilitates improvement of video encoding/decoding efficiency.

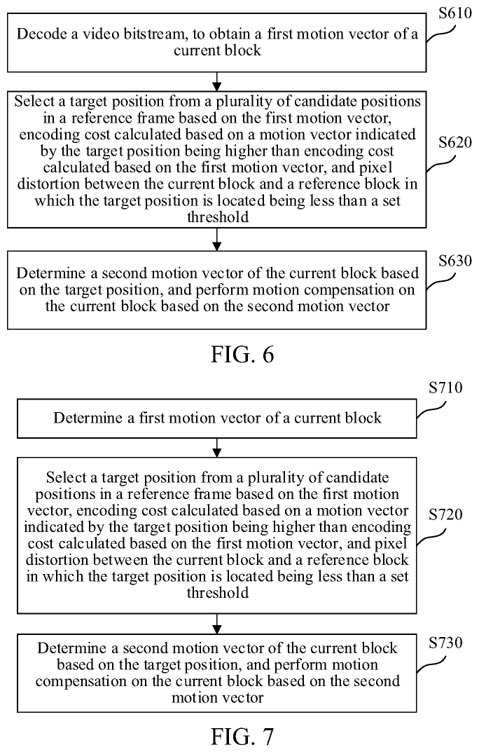

FIG. 6 is a flowchart of a video decoding method according to some embodiments. The video decoding method may be performed by an electronic device having a computing processing function, for example, may be performed by a terminal device or a server. Refer to FIG. 6. The video decoding method includes at least S610 to S630, which are described below in detail.

S610: Decode a video bitstream, to obtain a first MV of a current block.

In this operation, the first MV refers to an original MV of the current block.

In some embodiments, a video includes a video image frame sequence. The video image frame sequence includes a series of images. Each image may further be partitioned into slices. The slice may further be partitioned into a series of LCUs (or CTUs). The LCU includes several CUs. During encoding, a video image frame is encoded in units of blocks. In some novel video coding standards, such as H.264, a macroblock (MB) is proposed. The macroblock may further be partitioned into a plurality of prediction blocks configured for predictive coding. In the HEVC standard, concepts, such as a CU, a prediction unit (PU), and a transform unit (TU), are adopted to functionally partition various block units, which are described using a novel tree-based structure. For example, a CU may be partitioned into smaller CUs according to a quadtree, and the smaller CU may further be partitioned, to form a quadtree structure. The current block, the reference block, and the adjacent block in the embodiments of this application may be CUs or blocks smaller than the CU, for example, smaller blocks obtained by partitioning the CU.

In some embodiments, an inter prediction mode is adopted for the current block, which may be, for example, the Merge mode or the AMVP prediction mode.

In some embodiments, if the Merge mode is adopted for the current block, the video bitstream may be decoded to obtain an MV index of the current block, and then the first MV, namely, the original MV, of the current block is determined according to the MV index of the current block from a candidate MV list (namely, a Merge list) corresponding to the current block.

In some embodiments, if the AMVP mode is adopted for the current block, the video bitstream may be decoded to obtain an MVP index and an MVD of the current block, an MVP of the current block is determined according to the MVP index from a candidate MVP list corresponding to the current block, the original MV of the current block is determined based on the MVP and the MVD of the current block. In some embodiments, the original MV of the current block is equal to a sum of the MVP and the MVD.

S620: Select a target position from a plurality of candidate positions in a reference frame based on the first MV, encoding cost calculated based on an MV indicated by the target position being higher than encoding cost calculated based on the first MV, and pixel distortion between the current block and a reference block in which the target position is located being less than a set threshold.

In some embodiments, the plurality of candidate positions may be positions related to the original MV of the current block. For example, the plurality of positions may be determined from the vicinity of a position indicated by the original MV of the current block.

In some embodiments, if the Merge mode is adopted for the current block, the plurality of specified positions may include positions indicated by candidate MVs in the candidate MV list (that is, the Merge list). In this case, when the target position is selected, a target MV whose encoding efficiency is higher than encoding efficiency of the original MV and whose pixel distortion is less than the set threshold may be selected from the candidate MV list, and a position indicated by the target MV is the target position. That is, encoding cost calculated based on the target MV is higher than the encoding cost calculated based on the first MV, and the pixel distortion between the current block and the reference block in which the target position indicated by the target MV is located is less than the set threshold.

In some examples, the encoding efficiency may refer to an encoding bit rate, namely, data traffic used per unit time after an encoder encodes a video, or the encoding cost may refer to a quantity of bits for encoding an MV.

In some examples, the pixel distortion refers to a pixel difference between the current block and an optimal position block/reference block that is found in the reference frame. The difference may be a sum or an average of differences of pixels.

In some embodiments, if an index value in the candidate MV list is positively correlated with a value of encoding efficiency, a set of candidate MVs whose index values are greater than the MV index of the current block may be determined from the candidate MV list. The MV index of the current block is an index of the original MV in the foregoing embodiments, and encoding efficiency of the candidate MV in the candidate MV set is greater than encoding efficiency of the original MV of the current block. Further, a candidate MV whose pixel distortion is less than the set threshold may be selected from the candidate MV set as the target MV. In some embodiments, a candidate MV with minimum pixel distortion may be selected from the candidate MV set as the target MV.

In some embodiments, if the AMVP mode is adopted for the current block, the plurality of candidate positions are located within a position region that is determined based on the MVD and that is centered at a position indicated by the MVP of the current block. In this case, the process of selecting the target position may be: searching the position region for a position whose encoding efficiency is higher than encoding efficiency of the original MV and whose pixel distortion is less than the set threshold, and then using the found position as the target position.

In some embodiments, if an amplitude of the MVD is positively correlated with the value of encoding efficiency, a circular region centered at the position indicated by the MVP and having a radius equal to the amplitude of the MVD may be determined. Then, a region that is outside the circular region and that is within a set region centered at the position indicated by the MVP and having a predetermined size is used as a target position region.

In some embodiments, a search may be performed within the target position region for a position with minimum pixel distortion, and a found position is used as the target position.

In some embodiments, if a sum of absolute values of a horizontal coordinate and a vertical coordinate of the MVD is positively correlated with the value of encoding efficiency, a circular region centered at the position indicated by the MVP and having a radius equal to the sum of the absolute values of the horizontal coordinate and the vertical coordinate of the MVD may be determined. Then, a region that is outside the circular region and that is within a set region centered at the position indicated by the MVP and having a predetermined size is used as a target position region.

In some embodiments, a search may be performed within the target position region for a position with minimum pixel distortion, and a found position is used as the target position.

S630: Determine a second MV of the current block based on the target position, and perform motion compensation on the current block based on the second MV.

In some embodiments, after the target position is determined, a displacement between a position of the current block in a current image (or a current frame) and the target position may be used as a new MV of the current block, and then motion compensation may be performed on the current block based on the new MV. Because encoding efficiency (such as an encoding bit rate) of the new MV is higher than the encoding efficiency of the original MV of the current block, and pixel distortion is less than the set threshold, performing motion compensation on the current block based on the new MV can improve a motion compensation effect. This facilitates improvement of video encoding/decoding efficiency.

In some embodiments, after the new MV of the current block is determined, the new MV of the current block may be used as a temporal motion vector predictor (TMVP) for storage. The TMVP technology is an MVP method in time domain, and predicts an MV of a current block based on motion information of a corresponding position of the current block in an adjacent encoded image (a co-located image). This method helps reduce a volume of to-be-transmitted MV data, to improve encoding efficiency.

In some embodiments, after the new MV of the current block is determined, the original MV of the current block may be used as an MVP of a subsequent block; or may be not used as the MVP of the subsequent block but only configured for performing motion compensation on the current block.

In FIG. 6, the technical solution of the embodiments of this application is described from the perspective of video decoding. The technical solution of the embodiments of this application is described again below from the perspective of video encoding with reference to FIG. 7.

FIG. 7 is a flowchart of a video encoding method according to some embodiments. The video encoding method may be performed by an electronic device having a computing processing function, for example, may be performed by a terminal device or a server. Refer to FIG. 7, the video encoding method includes at least S710 to S730, which are described in detail below.

S710: Determine a first MV of a current block.

S720: Select a target position from a plurality of candidate positions in a reference frame based on the first MV, encoding cost calculated based on an MV indicated by the target position being higher than encoding cost calculated based on the first MV, and pixel distortion between the current block and a reference block in which the target position is located being less than a set threshold.

S730: Determine a second MV of the current block based on the target position, and perform motion compensation on the current block based on the second MV.

A processing process of a video encoding side is similar to a processing process of a video decoding side. For details, refer to the foregoing processing process related to the decoding side. Details are not described herein again.

In conclusion, the technical solution of the embodiments of this application primarily involves, during motion estimation, searching in a direction that increases encoding efficiency (such as an encoding bit rate) of an MV, to find a prediction position capable of reducing matching distortion (namely, pixel distortion). This enhances accuracy of pixel prediction. Compared with the related art, this application screens the encoding bit rat and the pixel distortion separately, rather than minimizing a weighted sum of the encoding bit rate and the pixel distortion.

After obtaining the predictor and the residual data of the current block, the decoding side may reconstruct the block, and then compares the reconstructed block with reference blocks at different positions in the reference frame to find the position with the minimum pixel distortion. In this way, a new MV for the current block is obtained.

In some embodiments, the decoding side obtains the MV of the current block in two manners based on whether an MVD exists.

If the Merge mode is adopted, positions in the Merge list may be re-evaluated, and an obtained MV is a final MV. In this case, no MVD exists. In some embodiments, it is assumed that a larger value of the index in the Merge list indicates higher encoding efficiency, a position to which an index (whose encoding efficiency is higher than encoding efficiency of a current index) following the index of the original MV of the current block points may be evaluated, and then compared with the position to which the MV corresponding to the current index points, and an MV corresponding to a position with minimum pixel distortion is selected as the new MV of the current block.

If the AMVP mode is adopted for the current block, an MV is determined by adding an MVD to the MVP value. After the encoding efficiency of the current block is calculated, a search is performed within a region whose value is greater than the encoding efficiency, to find a reference block whose pixel distortion with the current block is smaller.

In some embodiments, an amplitude of the MVD is positively correlated with a value of encoding efficiency. For example, the encoding efficiency increases as the amplitude

$$\sqrt{M V {D}_{x}^{2} + M V {D}_{y}^{2}}$$

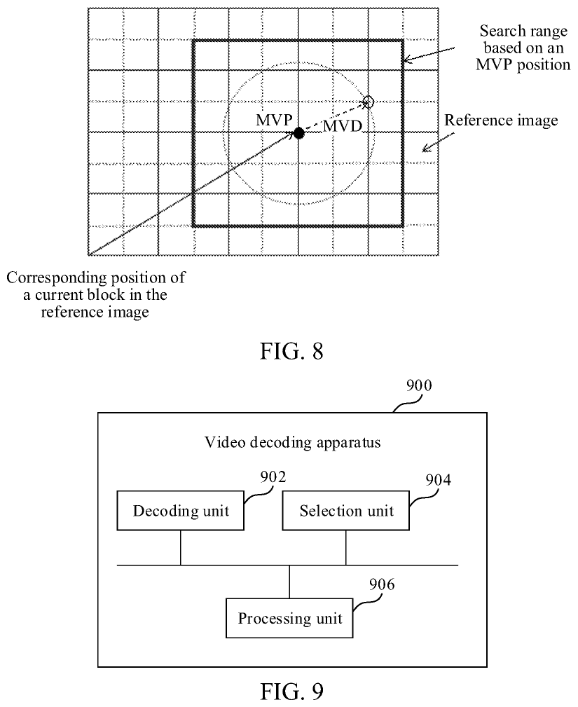

of the MVD increases. MVDₓ and MVD_{y} respectively represent a horizontal coordinate and a vertical coordinate of the MVD. As shown in FIG. 8, in the reference image, a circular region centered at a position indicated by the MVP and having a radius equal to the amplitude of the MVD is determined, as shown by a dashed circle. A set region centered at the position indicated by the MVP and having a predetermined size, as shown by a square box, is a search range based on the MVP position. A search is performed within a region (that is, a search region) that is outside the circular region and that is within the search range for a reference block matching the current block.

In another embodiment, a sum of absolute values of the horizontal coordinate and the vertical coordinate of the MVD is positively correlated with a value of encoding efficiency. For example, the encoding efficiency increases as |MVDₓ|+|MVD_{y}| increases. MVDₓ and MVD_{y} respectively represent the horizontal coordinate and the vertical coordinate of the MVD. Therefore, within the foregoing search range based on the MVP position shown in FIG. 8, a search is performed within a region (namely, a search region) centered at the position indicated by the MVP and having a radius greater than |MVDₓ|+|MVD_{y}| for a reference block matching the current block.

In the foregoing matching search process, an optimal position with minimum pixel distortion is found, and then a new MV of the current block is determined based on the optimal position. The search process may be represented by using the following formula:

$$min \{ D ( M V D ( i ) ) \vert M V D ( i ) ϵ T , R ( {MVD ( i )}_{x} , M V {D ( i )}_{y} ) > R ( M V {D}_{x} , {MVD}_{y} ) \}$$

where R (MVDₓ, MVD_{y}) indicates encoding efficiency (such as an encoding bit rate) at the MVD position obtained through decoding. D(MVD(i)) indicates pixel distortion between the reference block and the current block at the MVD(i) position, and a smaller value indicates a higher similarity between the reference block and the current block; and T indicates the search region.

In some embodiments, the foregoing new MV may be employed for motion compensation of the current block based on the foregoing new MV, and meanwhile, may be used as an MVP of a future coding block.

In some embodiments, the foregoing new MV may not be configured for predicting a subsequent coding block of the current image, and the original decoded MV is still used as a predictor of the subsequent coding block.

In some embodiments, the foregoing new MV may be stored as a temporal MVP (TMVP), to predict an MV of a future image frame.

In the technical solution of the foregoing embodiments of this application, the original MV of the current block is optimized, to reduce the pixel distortion. This can improve accuracy of the optimized MV, and facilitates improvement of video encoding/decoding efficiency. The technical solutions of the foregoing embodiments may be used alone, or may be used after being combined. In addition, the technical solution of the embodiments of this application may be applied to a related product such as a video encoder/decoder or video compression.

Apparatus embodiments of this application are described below, which may be configured to perform the method according to the foregoing embodiments of this application. For details not disclosed in the apparatus embodiments of this application, refer to the foregoing method embodiments of this application.

FIG. 9 is a block diagram of a video decoding apparatus according to some embodiments. The video decoding apparatus may be disposed in a device having a computing processing function, for example, may be disposed in a terminal device or a server.

Refer to FIG. 9. A video decoding apparatus 900 according to some embodiments includes: a decoding unit 902, a selection unit 904, and a processing unit 906.

The decoding unit 902 is configured to decode a video bitstream, to obtain a first MV of a current block.

The selection unit 904 is configured to select a target position from a plurality of candidate positions in a reference frame based on the first MV, encoding cost calculated based on an MV indicated by the target position being higher than encoding cost calculated based on the first MV, and pixel distortion between the current block and a reference block in which the target position is located being less than a set threshold.

The processing unit 906 is configured to determine a second MV of the current block based on the target position, and perform motion compensation on the current block based on the second MV.

In some embodiments, based on the foregoing solution, the decoding unit 902 is configured to:
decode the video bitstream, to obtain an MV index of the current block; and
determine, according to the MV index, the first MV from a candidate MV list corresponding to the current block.

In some embodiments, based on the foregoing solution, the plurality of candidate positions include positions indicated by candidate MVs in the candidate MV list.

The selection unit 904 is configured to select a target MV from the candidate MV list, encoding cost calculated based on the target MV being higher than the encoding cost calculated based on the first MV, and the pixel distortion between the current block and the reference block in which the target position indicated by the target MV is located being less than the set threshold.

In some embodiments, based on the foregoing solution, the selection unit 904 is configured to:
determine, when an index value in the candidate MV list is positively correlated with a value of encoding efficiency, a set of candidate MVs whose index values are greater than the MV index from the candidate MV list; and
select a candidate MV whose pixel distortion is less than the set threshold from the candidate MV set as the target MV.

In some embodiments, based on the foregoing solution, the selection unit 904 is configured to:
select a candidate MV with minimum pixel distortion from the candidate MV set as the target MV.

In some embodiments, based on the foregoing solution, the decoding unit 902 is configured to:
decode the video bitstream, to obtain an MVP index and an MVD of the current block;
determine, according to the MVP index, an MVP of the current block from a candidate MVP list corresponding to the current block; and
determine the first MV based on the MVP and the MVD.

In some embodiments, based on the foregoing solution, the selection unit 904 is configured to:
determine, based on the MVD, a position region centered at a position indicated by the MVP; and
perform a search within the position region for the target position.

In some embodiments, based on the foregoing solution, the selection unit 904 is configured to:
determine, when an amplitude of the MVD is positively correlated with a value of encoding efficiency, a circular region centered at the position indicated by the MVP and having a radius equal to the amplitude of the MVD; and
use a region that is outside the circular region and that is within a set region centered at the position indicated by the MVP and having a predetermined size as the position region.

In some embodiments, based on the foregoing solution, the selection unit 904 is configured to:
determine, when a sum of absolute values of a horizontal coordinate and a vertical coordinate of the MVD is positively correlated with a value of encoding efficiency, a circular region centered at the position indicated by the MVP and having a radius equal to the sum of the absolute values of the horizontal coordinate and the vertical coordinate of the MVD; and
use a region that is outside the circular region and that is within a set region centered at the position indicated by the MVP and having a predetermined size as the position region.

In some embodiments, based on the foregoing solution, the selection unit 904 is configured to:
use a position with minimum pixel distortion within the position region as the target position.

In some embodiments, based on the foregoing solution, the processing unit 906 is further configured to:
use the second MV as a TMVP for storage.

In some embodiments, based on the foregoing solution, the processing unit 906 is further configured to:
use the first MV as an MVP of a subsequent block of the current block.

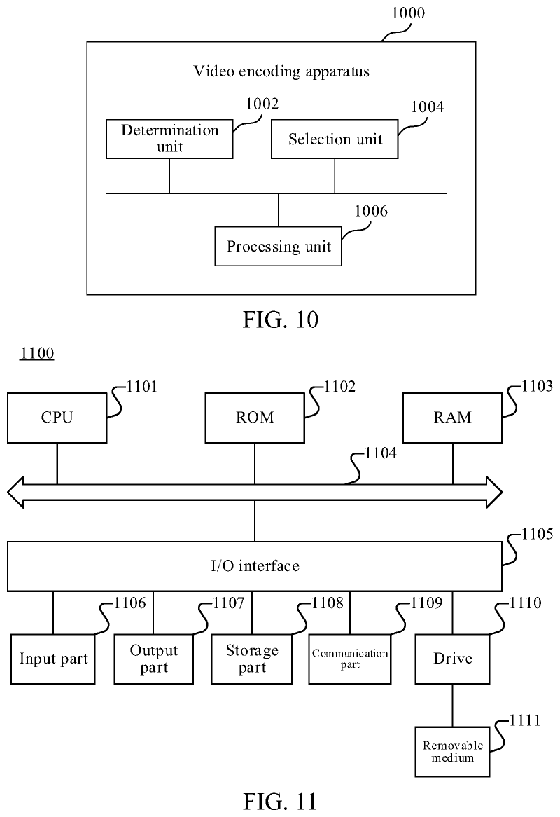

FIG. 10 is a block diagram of a video encoding apparatus according to some embodiments. The video encoding apparatus may be disposed in a device having a computing processing function, for example, may be disposed in a terminal device or a server.

Refer to FIG. 10. A video encoding apparatus 1000 according to some embodiments includes: a determination unit 1002, a selection unit 1004, and a processing unit 1006.

The determination unit 1002 is configured to determine a first MV of a current block.

The selection unit 1004 is configured to select a target position from a plurality of candidate positions in a reference frame based on the first MV, encoding cost calculated based on an MV indicated by the target position being higher than encoding cost calculated based on the first MV, and pixel distortion between the current block and a reference block in which the target position is located being less than a set threshold.

The processing unit 1006 is configured to determine a second MV of the current block based on the target position, and perform motion compensation on the current block based on the second MV.

FIG. 11 is a schematic structural diagram of an electronic device suitable for implementing embodiments of this application. The electronic device may be the video encoding apparatus or the video decoding apparatus in the foregoing embodiments.

An electronic device 1100 shown in FIG. 11 is merely an example, and does not constitute any limitation on the functions and scope of use of the embodiments of this application.

As shown in FIG. 11, the electronic device 1100 includes a central processing unit (CPU) 1101 that may perform various suitable actions and processes according to a program stored in a read-only memory (ROM) 1102 or a program loaded from a storage part 1108 into a random-access memory (RAM) 1103, for example, performs the method according to the foregoing embodiments. The RAM 1103 further has various programs and data for system operation stored therein. The CPU 1101, the ROM 1102, and the RAM 1103 are connected to each other through a bus 1104. An input/output (I/O) interface 1105 is further connected to the bus 1104.

The following components may be connected to the I/O interface 1105: an input part 1106 including a keyboard, a mouse, and the like; an output portion 1107 including a cathode ray tube (CRT), a liquid crystal display (LCD), a speaker, and the like; the storage part 1108 including a hard disk and the like; and a communication part 1109 including a network interface card such as an LAN card or a modem. The communication part 1109 performs communication processing by using a network such as the Internet. A drive 1110 is further connected to the I/O interface 1105 as required. A removable medium 1111, such as a magnetic disk, an optical disk, a magneto-optical disk, or a semiconductor memory, is equipped on the drive 1110 as required. In this way, a computer program read from the removable medium is loaded into the storage part 1108 as required.

Particularly, according to the embodiments of this application, the process described above with reference to the flowchart may be implemented as a computer software program. For example, embodiments of this application include a computer program product. The computer program product includes a computer program carried on a computer-readable storage medium. The computer program is configured for implementing the method shown in the flowchart. In such embodiments, the computer program may be downloaded and loaded by the communication part 1109 over a network, and/or loaded from the removable medium 1111. The computer program, when executed by the CPU 1101, implements various functions defined in the system of this application.

The computer-readable storage medium described in the embodiments of this application may be a computer-readable signal medium, a computer-readable storage medium, or any combination of the two. The computer-readable storage medium may be, but is not limited to, for example an electric, magnetic, optical, electromagnetic, infrared, or semi-conductive system, apparatus, or device, or any combination of the above. More examples of the computer-readable storage medium may include, but are not limited to, an electrical connection having one or more wires, a portable computer disk, a hard disk, an RAM, an ROM, an erasable programmable ROM (EPROM), a flash memory, an optical fiber, a portable compact disc ROM (CD-ROM), an optical storage device, a magnetic storage device, or any appropriate combination of the above. In this application, the computer-readable storage medium may be any tangible medium including or storing a computer program. The computer program may be used by or in combination with an instruction execution system, apparatus, or device. In this application, the computer-readable signal medium may include a data signal propagated in baseband or as part of a carrier wave, which carries a computer-readable computer program. The data signal propagated in such a manner may be implemented in a plurality of forms, including but not limited to, an electromagnetic signal, an optical signal, or any appropriate combination thereof. The computer-readable signal medium may alternatively be any computer-readable medium other than the computer-readable storage medium. The computer-readable medium may transmit, propagate, or transfer a program used by or in combination with an instruction execution system, apparatus, or device. The computer program included in the computer-readable medium may be transmitted by using any appropriate medium, including but not limited to, a wireless medium, a wired medium, or any appropriate combination thereof.

The flowcharts and block diagrams in the drawings illustrate possible system architectures, functions, and operations that may be implemented by the system, method, and computer program product according to various embodiments of this application. Each block in the flowchart or the block diagram may represent a module, a program segment, or a part of code. The module, program segment, or part of code includes at least one executable instruction configured for implementing a specified logical function. In some alternative implementations, functions annotated in the blocks may alternatively be executed in order different from those annotated in the drawings. For example, two blocks shown in succession may actually be performed basically in parallel, and sometimes the two blocks may be performed in reverse order. This depends on the functions involved. Each block in the block diagram or the flowchart and a combination of blocks in the block diagram or the flowchart may be implemented by a dedicated hardware-based system that performs specified functions or operations, or may be implemented by a combination of dedicated hardware and a computer instruction.

A related unit described in the embodiments of this application may be implemented in the form of software, or may be implemented in the form of hardware, or the described unit may be disposed in a processor. Names of these units do not constitute a limitation on the units in a case.

In another aspect, this application further provides a computer-readable medium. The computer-readable medium may be included in the electronic device described in the foregoing embodiments; or the electronic device may exist alone and is not assembled into the electronic device. The computer-readable medium carries one or more computer programs. The one or more computer programs, when executed by an electronic device, causes the electronic device to implement the method described in the foregoing embodiments.

Although a plurality of modules or units of a device configured to perform actions are mentioned in the foregoing detailed description, such division is not mandatory. In practice, according to the implementations of this application, the features and functions of the two or more modules or units described above may be embodied in one module or unit. Rather, the features and functions of one module or unit described above may further be divided to be embodied by a plurality of modules or units.

Through the foregoing description of the implementations, a person skilled in the art may readily understand that the exemplary implementations described herein may be implemented by using software, or may be implemented by using a combination of software and necessary hardware. Therefore, the technical solutions according to the implementations of this application may be embodied in the form of a software product. The software product may be stored in a non-volatile storage medium (which may be a CD-ROM, a Universal Serial Bus (USB) flash drive, a removable hard disk, or the like) or on the network, including several instructions for enabling an electronic device to perform the method according to the implementations of this application.

For example, the electronic device may be a video decoding apparatus, and the video decoding apparatus may perform the video decoding method shown in FIG. 6. For another example, the electronic device may be a video encoding apparatus, and the video encoding apparatus may perform the video encoding method shown in FIG. 7.

A person skilled in the art can easily figure out other implementations of this application after considering the description and practicing the implementations disclosed herein. This application is intended to cover any variations, usages, or adaptive changes of this application. These variations, usages, or adaptive changes follow the general principles of this application and include common general knowledge or common technical means in the technical field not disclosed in this application.

This application is not limited to the precise structures described above and shown in the drawings, and various modifications and changes may be made without departing from the scope of this application. The scope of this application is subject only to the appended claims.

What is claimed is:

1. A video decoding method, performed by an electronic device and comprising:
decoding a video bitstream to obtain a first motion vector of a current block;
identifying, in a reference frame, a plurality of candidate positions associated with the first motion vector;
selecting a target position from the plurality of candidate positions;
determining a second motion vector of the current block based on the target position,
wherein the target position satisfies:
a first condition that a second encoding cost of the second motion vector indicated by the target position exceeds a first encoding cost of the first motion vector, and
a second condition that a pixel distortion between the current block and a reference block containing the target position is below a threshold; and
performing motion compensation on the current block based on the second motion vector.

2. The video decoding method according to claim 1, wherein the decoding the video bitstream comprises:
decoding the video bitstream to obtain a motion vector index of the current block; and
determining, based on the motion vector index, the first motion vector from a candidate motion vector list corresponding to the current block.

3. The video decoding method according to claim 2, wherein the plurality of candidate positions comprises positions indicated by candidate motion vectors in the candidate motion vector list; and
wherein the selecting the target position comprises:
selecting the second motion vector from the candidate motion vector list, wherein the target position is indicated by the second motion vector.

4. The video decoding method according to claim 3, wherein the selecting the second motion vector from the candidate motion vector list comprises:
determining, based on an index value in the candidate motion vector list being positively correlated with encoding efficiency, a candidate motion vector set from the candidate motion vector list, each candidate motion vector in the candidate motion vector set having an index value exceeding the motion vector index; and
selecting, from the candidate motion vector set as the second motion vector, a candidate motion vector with a pixel distortion below the threshold.

5. The video decoding method according to claim 4, wherein the selecting the candidate motion vector from the candidate motion vector set comprises:
selecting, from the candidate motion vector set as the second motion vector, a candidate motion vector with a minimum pixel distortion.

6. The video decoding method according to claim 1, wherein the decoding the video bitstream comprises:
decoding the video bitstream to obtain a motion vector predictor index and a motion vector difference of the current block;
determining, based on the motion vector predictor index, a motion vector predictor of the current block from a candidate motion vector predictor list corresponding to the current block; and
determining the first motion vector based on the motion vector predictor and the motion vector difference.

7. The video decoding method according to claim 6, wherein the selecting the target position comprises:
determining, based on the motion vector difference, a position region centered at a position indicated by the motion vector predictor; and
performing a search within the position region for the target position.

8. The video decoding method according to claim 7, wherein the determining the position region comprises:
determining, based on an amplitude of the motion vector difference being positively correlated with encoding efficiency, a circular region centered at the position indicated by the motion vector predictor and having a radius equal to the amplitude of the motion vector difference; and
using, as the position region, a region outside the circular region and within a set region centered at the position indicated by the motion vector predictor and having a predetermined size.

9. The video decoding method according to claim 7, wherein the determining the position region comprises:
determining, based on a sum of absolute values of a horizontal coordinate and a vertical coordinate of the motion vector difference being positively correlated with encoding efficiency, a circular region centered at the position indicated by the motion vector predictor and having a radius equal to the sum of the absolute values of the horizontal coordinate and the vertical coordinate of the motion vector difference; and
using, as the position region, a region outside the circular region and within a set region centered at the position indicated by the motion vector predictor and having a predetermined size.

10. The video decoding method according to claim 8, wherein the performing the search comprises:
using, as the target position, a position with a minimum pixel distortion within the position region.

11. A video decoding apparatus, comprising:
at least one memory configured to store program code; and
at least one processor configured to read the program code and operate as instructed by the program code, the program code comprising:
decoding code configured to cause at least one of the at least one processor to decode a video bitstream to obtain a first motion vector of a current block;
identifying code configured to cause at least one of the at least one processor to identify, in a reference frame, a plurality of candidate positions associated with the first motion vector;
selecting code configured to cause at least one of the at least one processor to select a target position from the plurality of candidate positions;
determining code configured to cause at least one of the at least one processor to determine a second motion vector of the current block based on the target position,
wherein the target position satisfies:
a first condition that a second encoding cost of the second motion vector indicated by the target position exceeds a first encoding cost of the first motion vector, and
a second condition that a pixel distortion between the current block and a reference block containing the target position is below a threshold; and
compensation code configured to cause at least one of the at least one processor to perform motion compensation on the current block based on the second motion vector.

12. The apparatus according to claim 11, wherein the decoding code is further configured to cause at least one of the at least one processor to:
decode the video bitstream to obtain a motion vector index of the current block; and
determine, based on the motion vector index, the first motion vector from a candidate motion vector list corresponding to the current block.

13. The apparatus according to claim 12, wherein the plurality of candidate positions comprises positions indicated by candidate motion vectors in the candidate motion vector list; and
wherein the selecting code is further configured to cause at least one of the at least one processor to:
select the second motion vector from the candidate motion vector list, wherein the target position is indicated by the second motion vector.

14. The apparatus according to claim 13, wherein the selecting code is further configured to cause at least one of the at least one processor to:
determine, based on an index value in the candidate motion vector list being positively correlated with encoding efficiency, a candidate motion vector set from the candidate motion vector list, each candidate motion vector in the candidate motion vector set having an index value exceeding the motion vector index; and
select, from the candidate motion vector set as the second motion vector, a candidate motion vector with a pixel distortion below the threshold.

15. The apparatus according to claim 14, wherein the selecting code is further configured to cause at least one of the at least one processor to:
select, from the candidate motion vector set as the second motion vector, a candidate motion vector with a minimum pixel distortion.

16. The apparatus according to claim 11, wherein the decoding code is further configured to cause at least one of the at least one processor to:
decode the video bitstream to obtain a motion vector predictor index and a motion vector difference of the current block;
determine, based on the motion vector predictor index, a motion vector predictor of the current block from a candidate motion vector predictor list corresponding to the current block; and
determine the first motion vector based on the motion vector predictor and the motion vector difference.

17. The apparatus according to claim 16, wherein the selecting code is further configured to cause at least one of the at least one processor to:
determine, based on the motion vector difference, a position region centered at a position indicated by the motion vector predictor; and
perform a search within the position region for the target position.

18. The apparatus according to claim 17, wherein the selecting code is further configured to cause at least one of the at least one processor to:
determine, based on an amplitude of the motion vector difference being positively correlated with encoding efficiency, a circular region centered at the position indicated by the motion vector predictor and having a radius equal to the amplitude of the motion vector difference; and
use, as the position region, a region outside the circular region and within a set region centered at the position indicated by the motion vector predictor and having a predetermined size.

19. The apparatus according to claim 17, wherein the selecting code is further configured to cause at least one of the at least one processor to:
determine, based on a sum of absolute values of a horizontal coordinate and a vertical coordinate of the motion vector difference being positively correlated with encoding efficiency, a circular region centered at the position indicated by the motion vector predictor and having a radius equal to the sum of the absolute values of the horizontal coordinate and the vertical coordinate of the motion vector difference; and
use, as the position region, a region outside the circular region and within a set region centered at the position indicated by the motion vector predictor and having a predetermined size.

20. A non-transitory computer-readable storage medium, storing computer code which, when executed by at least one processor, causes the at least one processor to at least:
decode a video bitstream to obtain a first motion vector of a current block;
identify, in a reference frame, a plurality of candidate positions associated with the first motion vector;
select a target position from the plurality of candidate positions;
determine a second motion vector of the current block based on the target position,
wherein the target position satisfies:
a first condition that a second encoding cost of the second motion vector indicated by the target position exceeds a first encoding cost of the first motion vector, and
a second condition that a pixel distortion between the current block and a reference block containing the target position is below a threshold; and
perform motion compensation on the current block based on the second motion vector.
